(19) United States
(12) Patent Application Publication
(10) Pub. No.: US 2019/0136413 A1
(43) Pub. Date: May 9, 2019

(54) Patterning of Thermally-Drawn Fibers and Textiles Including Such Fibers

(71) Applicant: Massachusetts Institute of Technology, Cambridge, MA (US)

(72) Inventors: Yoel Fink, Brookline, MA (US); Tural Khudiyev, Revere, MA (US); Chong Hou, Cambridge, MA (US)

(73) Assignee: Massachusetts Institute of Technology, Cambridge, MA (US)

(21) Appl. No.: 15/983,051

(22) Filed: May 17, 2018

Related U.S. Application Data
(60) Provisional application No. 62/507,985, filed on May 18, 2017.

(51) Int. Cl. D01D 5/253; D01D 1/00; D03D 3/02; D01F 6/64; D01F 6/16; B23C 3/13; B23C 3/30

(52) U.S. Cl. CPC D01D 5/253; D01D 1/00; D03D 3/02; D01F 6/64; D01F 6/16; D10B 2321/08; B23C 3/30; D10B 2401/021; D10B 2331/04; D10B 2401/20; B23C 3/13

(57) ABSTRACT

Provided is a fiber having an elongated, unsupported, three-dimensional fiber body with a fiber body length and at least one fiber material disposed along the fiber body length. The at least one fiber material has a viscosity lower than about 10⁸ Poise at a common thermal fiber draw temperature. At least one topological pattern is disposed on at least one surface of the fiber body and extends longitudinally along at least a portion of the fiber body length. To form the fiber, there is assembled a fiber preform including at least one preform material. A surface of at least one preform material is patterned and arranged as a fiber preform surface, providing a topological pattern on a fiber preform surface. The fiber preform is thermally drawn into an elongated fiber at a fiber draw temperature at which all preform materials have a viscosity lower than about 10⁸ Poise.

### CROSS-REFERENCE TO RELATED APPLICATION

This application claims the benefit of U.S. Provisional Patent Application No. 62/507,985, filed May 18, 2017, the entirety of which is hereby incorporated by reference.

### STATEMENT REGARDING FEDERALLY SPONSORED RESEARCH

This invention was made with Government support under Contract No. DMR-1419807, awarded by the National Science Foundation, and under Contract No. W911NF-13-D-001, awarded by the Army Research Office. The Government has certain rights in the invention.

### BACKGROUND

This invention relates generally to fibers, and more particularly relates to the patterning of fibers.

The worldwide annual production volume of textile fibers is nearly one hundred million metric tons. Most production fibers are post-production processed by, e.g., a chemical treatment, to achieve one or more desired fiber properties such as color, hydrophobicity, antimicrobial properties, UV-protection and other properties. But chemical-based textile treatments come with significant societal penalties, including adverse health and environmental effects, as well as tremendous energy expenditures. It is therefore increasingly considered that chemical processing of fiber is not sustainable or healthy.

In addition to considerations of health and environmental effects, fiber processing to achieve desired fiber surface properties has significant technical limitations. While surface processing, e.g., surface patterning, is a mature technique that is widely employed in fields like electronics, photonics, the difficulty in and cost of surface patterning increases sharply as pattern feature size and pattern area extent decrease. While centimeter scale patterning and millimeter scale patterning of macro structures can be relatively easily implemented with production-level processes, micro-scale and nano-scale patterning of structures, and particularly of fiber-scale structures, is generally limited to laboratory processing, due to the relatively high expense and extended processing times required. As a result, the microscopic surface patterning of fiber has not been achievable at a production-level, and the many applications for patterned fiber have not been fulfilled.

### SUMMARY

To overcome the limitations of prior micro-scale patterning processes, there is provided herein a method for forming a patterned fiber. In the method, there is assembled a fiber preform including at least one preform material. A surface of at least one preform material is patterned and is arranged as a fiber preform surface, to provide a topological pattern on a fiber preform surface. The fiber preform is then thermally drawn into an elongated fiber at a fiber draw temperature at which all preform materials have a viscosity lower than about 10⁸ Poise.

This method enables the production of a fiber having an elongated, unsupported, three-dimensional fiber body with a fiber body length and at least one fiber material disposed along the fiber body length. The at least one fiber material has a viscosity lower than about 10⁸ Poise at a common thermal fiber draw temperature. At least one topological pattern is disposed on at least one surface of the fiber body and extends longitudinally along at least a portion of the fiber body length.

With the ability to produce kilometers of microscale topological fiber features, the process provided herein enables a wide range of applications, including micro-fluidics and nano-fluidics, plasmonic metasurfaces, smart surfaces, organic photonic, biosensors, smart textiles, and other applications.

Other features and advantages of the fiber will be apparent from the following description and accompanying figures, and from the claims.

### BRIEF DESCRIPTION OF THE DRAWINGS

FIG. 1A is a schematic view of apparatus for thermally drawing a patterned fiber preform into an elongated, mechanically flexible, patterned fiber;

FIG. 1B is a micrograph of a patterned preform necking down into a patterned fiber during a thermal draw process;

FIG. 1C is a flow chart of steps in the production of a thermally-drawn patterned fiber;

FIG. 2A is a schematic perspective view of a patterned fiber including a grating pattern on a surface thereof;

FIG. 2B is a schematic perspective view of a thermally-drawn patterned fiber wound on a spool;

FIG. 2C is a schematic cross-sectional view of a thermally-drawn patterned fiber including a plurality of domains within the fiber body;

FIG. 3A is a schematic perspective view of a fiber preform including a surface pattern on one surface thereof;

FIGS. 3B-3C are schematic cross-sectional views of a patterned preform having a triangular and square surface topology, respectively;

FIG. 3D is a schematic cross-sectional view of a thermally drawn patterned fiber having hemispherical patterns on one surface thereof;

FIGS. 4A-4B are schematic cross-sectional views of a patterned preform having different chirped grating patterns on a surface thereof;

FIGS. 5A-5B are schematic cross-sectional views of a patterned preform having a single patterned trench and triangle, respectively, on a preform surface;

FIG. 6A is a schematic view of a process for laser cutting patterns into a fiber preform;

FIG. 6B is a schematic view of a process for milling patterns into a fiber preform;

FIGS. 7A-7C are schematic views of a process for assembling a fiber preform including a molding layer, thermally drawing the preform, and peeling apart fiber layers, respectively, to produce a molded and thermally drawn patterned fiber;

FIGS. 8A-8B are schematic cross-sectional views of a patterned preform having an internal surface patterned before, and after, consolidation of the preform, respectively;

FIGS. 9A-9E are schematic views of a process for assembling a patterned fiber preform, thermally drawing the patterned preform into a thermally-drawn patterned fiber, assembling and consolidating a second patterned fiber preform with cut sections of the thermally-drawn patterned fiber, and thermally drawing the second patterned fiber preform to produce a highly patterned, thermally-drawn fiber by iterative drawing;

FIG. 10A is a schematic diagram defining the diffraction pattern produced by a thermally-drawn patterned fiber including a diffraction grating on a surface of the thermally-drawn fiber;

FIGS. 10B-10C are micrographs of two different thermally-drawn fiber surface grating patterns;

FIGS. 10D-10E are the diffraction patterns produced by the fiber surface grating patterns of FIGS. 10B and 10C, respectively;

FIG. 10F is a schematic perspective view of the process in which light incident on a thermally drawn fiber surface grating causes diffraction that results in structural color change of the fiber;

FIGS. 10G-10H are photographs of thermally-drawn patterned fibers having structural coloration due to diffraction pattern for aligned fibers and for woven fibers, respectively;

FIGS. 11A, 11B, and 11C are schematic views of the process of a water droplet wetting on a patterned surface, unpatterned surface, and grating, respectively, on a patterned fiber;

FIGS. 11D, 11E, and 11F are views of the measured contact angle with the surfaces of FIGS. 11A-11C;

FIGS. 11G-11H are photographs of ink flow along a patterned fiber surface and on a bare fiber surface, respectively; and

FIG. 11I is a photograph of a thermally-drawn patterned fiber having one patterned surface and one unpatterned surface, demonstrating the hydrophobicity of the patterned surface.

### DETAILED DESCRIPTION

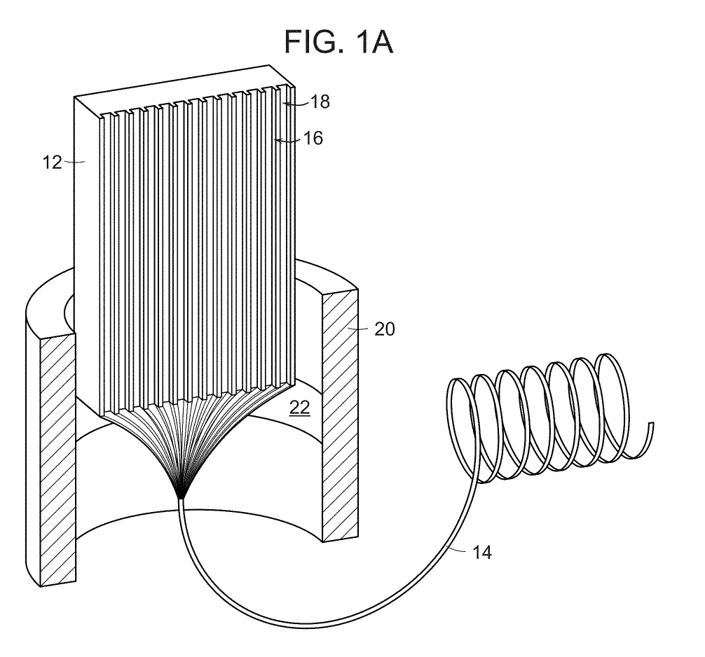

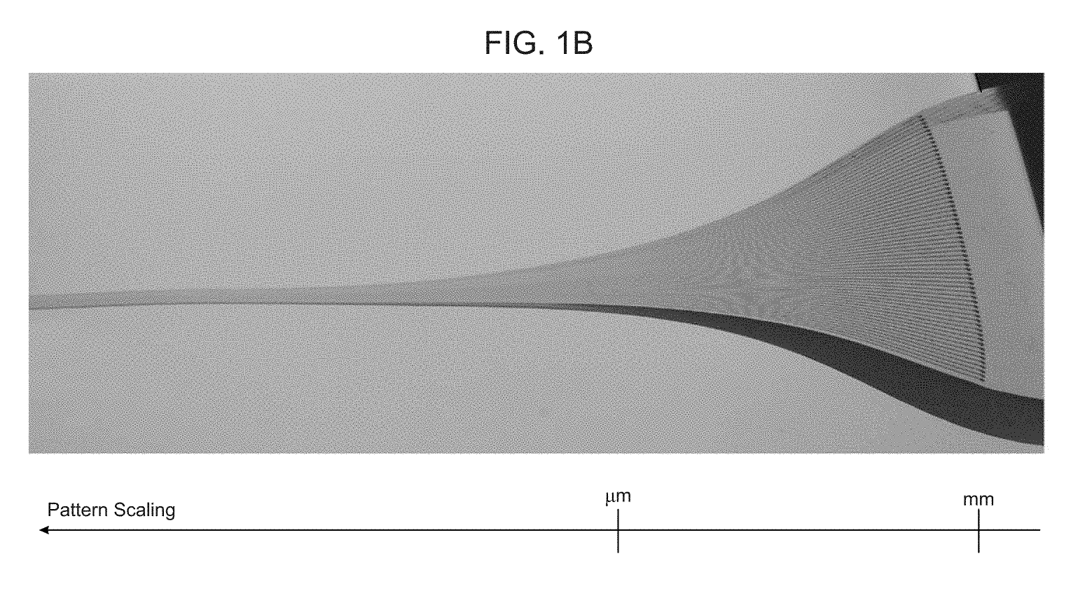

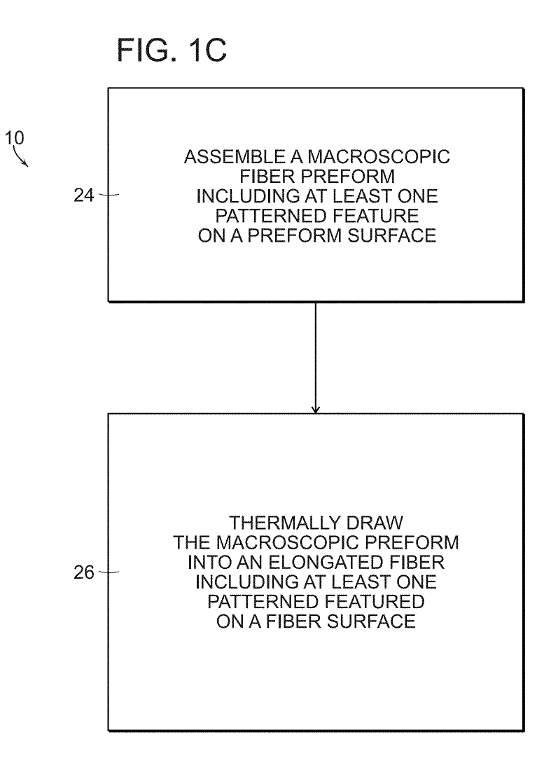

Referring to FIG. 1A, there is schematically shown the apparatus, method, and product for an example implementation of production of a patterned fiber as-provided herein. Referring also to the flow chart of FIG. 1C, in the method 10, a macroscopic fiber preform 12, that is, an arrangement of materials that is on the macro-scale, is assembled for thermal co-drawing of the preform materials into an elongated fiber 14. The fiber preform 12 includes one or more topological patterns 16 on one or more surfaces 18 of the preform and/or on one or more surfaces of material layers that are internal to the outer surface of the preform 12.

The preform is assembled of one or more materials that can together be thermally co-drawn into a mechanically flexible, longitudinally elongated, patterned fiber. The preform materials can be molten, softened, or for some isolated material regions, can remain solid, during the thermal draw of the preform. A fiber draw tower 20, arranged in the conventional manner with a middle draw zone 22, can be employed for thermally drawing the patterned preform into a patterned fiber. As shown in the micrograph of FIG. 1B, the thermal drawing of the fiber preform reduces the cross sectional extent of the fiber preform as well as reducing the dimensions of the surface patterns on the preform, from the millimeter scale to the micron or nanometer scale. The resulting fiber 14 has a significant length-to-cross section ratio and includes on one or more outer fiber surfaces and/or inner material layer surfaces a reduced-scale version of the pattern, feature, or patterns that were imposed on the fiber preform.

The patterned fiber production process 10 thereby employs two steps, namely, a first step 24 of assembling a macroscopic fiber preform that includes a patterned internal preform layer or layers and/or patterned outer preform surface or surfaces; and a second step 26 of thermal drawing of the patterned fiber preform 12 to produce a fiber 14 having micro-scale patterning on a fiber surface corresponding to the preform pattern. The thermal drawing process preserves the geometric organization of the preform patterns and features while simultaneously reducing the dimensions of the patterns as a function of the thermal draw parameters, as explained in detail below. The thermal drawing process also produces many kilometers of fiber length from one preform. As a result, the patterned fiber production process of FIGS. 1A-B provides submicron-scale patterned fiber over a very extended length, e.g., greater than a kilometer in length, with high spatial uniformity, and at processing speeds of at least about tens of meters per minute, which is at least an order of magnitude faster than the speed of conventional optical lithographic processes for production of microscale patterning of materials and surfaces.

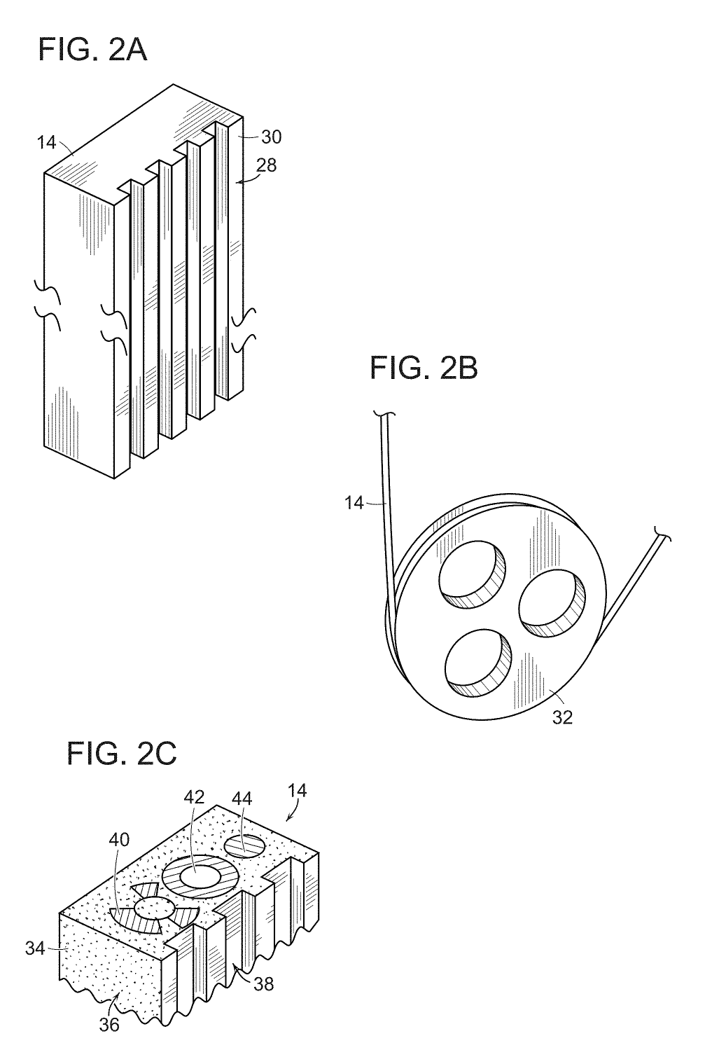

Referring to FIGS. 2A-2B, in one embodiment, the resulting patterned fiber 14 includes at least one feature or pattern 28 on one or more surfaces 30 of the body of the fiber 14. The patterned fiber is mechanically flexible along the fiber length, and therefore can be spooled, as in FIG. 2B, on a spool 32 or other apparatus. The fiber is a three-dimensional, unsupported, i.e., free-standing, self-supported object for which the fiber's longitudinal extent, along the fiber length, is at least an order of magnitude larger than the fiber's cross sectional extent. The fiber length is on the order of meters, e.g., more than 1 meter, more than 10 meters, or more than 50 meters, more than 100 meters, or longer, e.g., kilometers. The cross-sectional extent of the fiber is micro-scale, e.g., between about 10 μm and 100 μm, and less than about 2000 μm. In one embodiment, the longitudinal-to-cross sectional ratio of the drawn fiber is greater than 1000.

Conversely, the fiber preform 12 (FIG. 1A) has a cross-sectional extent that in one embodiment is between about 10 mm to about 100 mm and a preform length that is on the order of centimeters, e.g., about 100 cm or less. The preform is characterized by a ratio of longitudinal to cross sectional dimensions that is typically between about 2 and about 100. The preform-to-fiber draw down ratio that transforms the preform dimensionality to the fiber dimensionality can range from about 10 to greater than about 500. As shown in FIG. 1B, the pattern feature size is also reduced by the draw down ratio, and thus, while preserving the geometry of the preform pattern features, the thermal drawing process effectively miniaturizes the pattern features and provides the miniaturized features on a flexible, elongated structure that is the fiber body.

To preserve the geometrical configuration of the pattern features, the cross-sectional feature size of the preform is reduced by the thermal draw conditions but surface energy-driven deformation of non-equilibrium surface features is substantially suppressed by the thermal draw conditions. This preservation of pattern features during the thermal draw process is achieved by controlling the draw temperature, the preform feed speed through the heated drawing zones, the fiber draw speed, such that the thermomechanical scale-down process of the fiber draw occurs at a sufficiently high stress at which viscous forces dominate and surface energy-driven deformations are kinetically restrained. For example, for many fiber materials, a thermal draw speed of between about 1 m/min and about 10 m/min can be preferred; a preform feed speed of about 1 mm/min can be preferred; a draw stress of between about 400 g/mm² and about 1000 g/mm² can be preferred to substantially prevent surface deformation of preform materials during the thermal draw, and a draw tower furnace having a top zone temperature of about 150° C., a middle zone temperature of between about 220° C. and about 280° C., and a bottom zone temperature of about 110° C. can be preferred. In one embodiment, the preform feed speed is about 1 mm/min, the draw speed is about 1 m/min, and the top, middle, and bottom draw tower zones are set at temperatures of about 150° C., 240° C., and 110° C., respectively.

With this process control, there is provided herein a fiber including uniformity in fiber pattern both along both the axial, i.e., longitudinal, fiber direction as well as in the transverse, i.e., cross-sectional fiber direction. For example, given a surface grating pattern on a patterned fiber, the standard deviation of grating width along 5 meters of the fiber is in one embodiment only a about 1%. Highly precise, well-controlled patterns are thereby provided by the methods herein.

In general, the fiber preform is assembled of materials that can be thermally co-drawn from a preform arrangement into mechanically flexible, elongated fiber form. Example suitable materials include amorphous polymers such as polycarbonate, PMMA, and COC; semicrystalline polymers such as polyethylene, PVDF; fluoropolymers such as PVDF; acrylates, such as PMMA; carbonates, such as PC; olefins, such as COC; thermoplastics, such as PC, PMMA, PEI, PI, and PSU; and other polymers, such as elastomers, polyetherimide, and other materials. The fiber can include electrically conducting materials, such as electrically conductive polyethylene; electrically semiconducting materials, such as arsenic selenide and arsenic sulfide, and electrically insulating materials like the polymers described just above. In general, there is no limitation to the materials to be included in the fiber preform except that each of the materials be characterized by a viscosity at the selected draw temperature that enables the materials to be thermally co-drawn from a fiber preform into a fiber.

In one embodiment, referring to FIG. 2C, the thermally drawn patterned fiber 14 includes one or more different, distinct domains within the fiber body 34 extending along the fiber length or portions of the fiber length. A material for the fiber body 34 provides outer fiber surfaces 36 on which there can be provided surface patterning 38. Within the fiber body 34, there can be included one or more fiber domains 40, 42, 44 that are of various geometries, materials, and functionalities. Hollow domains 42 and domains having distinct and separate functions, e.g., including optical transmission, electrical transmission, sensing, and transduction, can be included. There can also be included electrical devices at sites within the preform body, arranged and included as taught in, e.g., U.S. Patent Application Publication No. US2018/0039036, published Feb. 8, 2018, the entirety of which is hereby incorporated by reference. Each domain included in the fiber preform assembly can have a different surface pattern. The fiber body 34 is formed of a material that can encapsulate the inner fiber domains and/or devices and that operates as an outer fiber cladding layer.

Whatever domains are to be included in the patterned fiber, the materials included in the preform can be thermally co-drawn into a fiber. A reasonable criterion for this condition is that the material that is arranged as the preform body can flow during the thermal draw process by having a viscosity lower than about 10⁸ Poise at a selected draw temperature. For example, given a polymer fiber body material, then a polymer fiber body viscosity of between about 10¹ Poise and about 10⁸ Poise can be acceptable, with a viscosity of between about 10⁴ Poise and about 10⁷ Poise more preferred, at the selected fiber draw temperature.

With the ability to co-draw the fiber preform materials, the patterned preform is arranged and thermally drawn into the patterned fiber by one or more thermal drawing techniques as taught in U.S. Pat. No. 7,295,734, issued Nov. 13, 2007; as taught in U.S. Pat. No. 7,292,758, issued Nov. 6, 2007; as taught in U.S. Pat. No. 7,567,740, issued Jul. 28, 2009; as taught in U.S. Pat. No. 9,263,614, issued Feb. 16, 2016; as taught in U.S. Pat. No. 9,365,013, issued Jun. 14, 2016; as taught in U.S. Pat. No. 9,512,036, issued Dec. 6, 2016; as taught in U.S. Patent Application Publication No. 2015/0044463, published Feb. 12, 2015; as taught in U.S. Patent Application Publication No. 2014/0272411, published Sep. 18, 2014; and as taught in “Sub-Micrometer Surface-Patterned Ribbon Fibers and Textiles,” Adv. Mater., V. 29, pp. 1605868 1-6, 2017, the entirety of all of which are hereby incorporated by reference.

During the thermal draw process, it is preferred to manage heat flow on the surface of the preform, as the preform necks down to a fiber, to preserve the integrity of surface feature geometry on the fiber surface during the draw. In one embodiment, active or passive cooling of the surface is conducted during the fiber draw. Cooling with a gas by the direction of gas flow across the surface of the preform-to-fiber neck can be particularly effective. The directed gas flow can induce forced convection on the surface, which balances the viscosity of a surface patterned region with the viscosity of the bulk region beneath the surface. Depending on the requirements for a particular application, a gas flow, such as a nitrogen flow, can be controlled by gas flow rate and spatial gas direction across the surface to achieve optimal surface cooling during the thermal draw process, so that heat buildup across fiber surface is minimized or prevented. Complex surface features can then be preserved as the fiber preform necks down into the fiber.

In one embodiment provided herein, in the preform patterning step, one or more outer preform surfaces or internal perform surfaces or layers are physically processed to form topological features, such as a topological pattern, on the preform surface or layer. The term ‘pattern’ is thus used herein to refer to the process of imposing topological features on a surface, and also is used to refer to a topological feature or features. One shape or feature can be repeated at regular intervals, effectively forming an array, or an arrangement of different lines, shapes, geometries, and topological features can constitute a pattern. In the preform patterning process, along at least a portion of the extent of a layer or a portion of a side of the preform surface, there is imposed at least one topological feature. Each feature has a feature depth into the preform surface or into a preform layer and a feature width across a preform surface or across a preform layer. In one embodiment, a plurality of features are imposed across the preform surface or a preform layer. In a further embodiment, a feature is repeated as a pattern of features. In a further embodiment there are provided on a preform surface or a preform layer features that are different from each other and/or there is provided a plurality of features that are substantially identical. Features and/or a pattern of features can extend the full length or width of a preform surface or preform layer, can extend across a portion of a preform surface or layer, or can be provided at selected sites on a preform surface or layer.

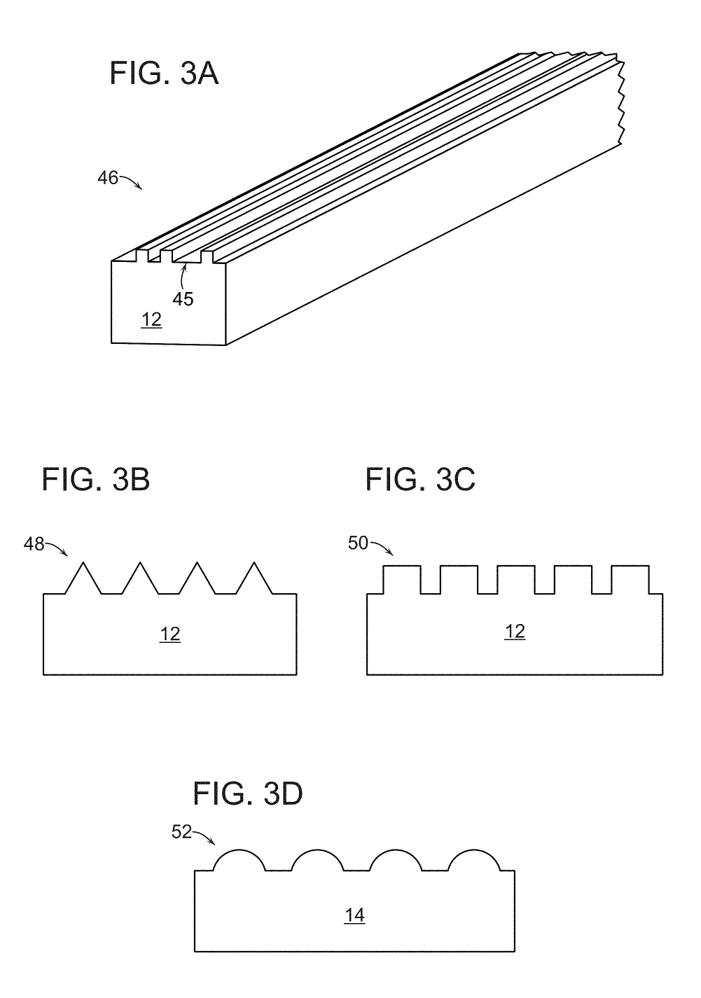

Referring to FIG. 3A, a fiber preform 12 can be patterned to include on a preform surface 45 a spaced-apart pattern, e.g., a regular pattern of trenches, pillars 46, or other feature, which in one embodiment extend the length of the preform. Referring to FIGS. 3B-3C, showing cross-sectional views of a preform 12, a spaced-apart pattern of, e.g., triangular features 48, square features 50, or other feature geometry, can be imposed. The cross-sectional pattern topology can be trapezoidal, spherical, oval, polygonal, or other selected geometry. In one embodiment, the features of a fiber preform are selected so that the thermal draw process conditions alter the features to form desired fiber features. For example, the thermal drawing of a fiber preform 12 having square surface features 50 as in FIG. 3C, under a drawing condition of low stress, i.e., under thermal draw conditions of low material viscosity, causes natural tapering of the square preform features 50 into hemispherical shapes 52 on the drawn fiber 14, as shown in FIG. 3D.

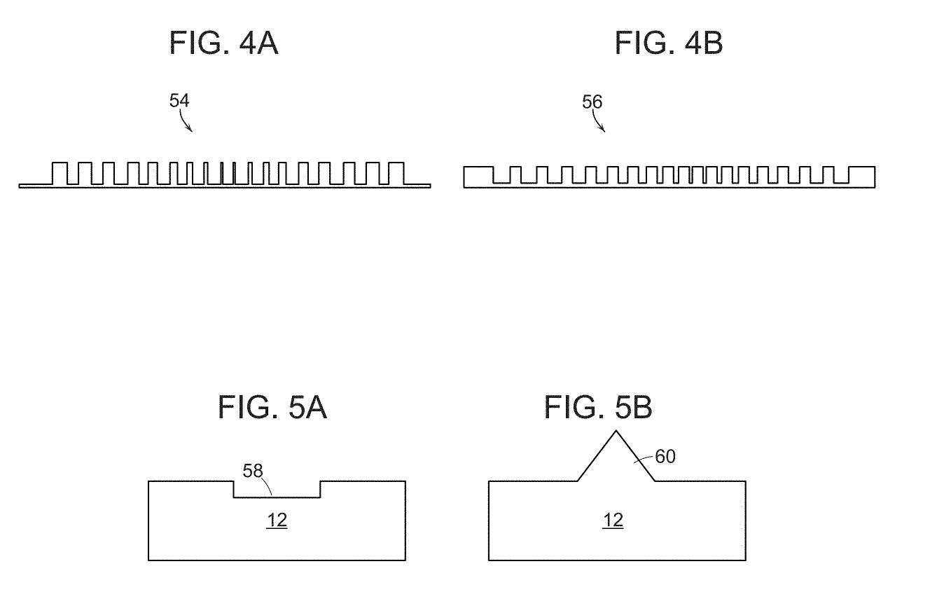

In one embodiment, using, e.g., macro-scale methods and tools, both the height and period of spacing between topological features can be arbitrarily varied across a preform layer or surface. For example, referring to FIGS. 4A-4B, chirped grating structures 54, 56, can be imposed on a fiber preform surface. Periodicity, height, and other feature factors and geometry can be changed across a pattern of features and/or across the surface of a preform. The thermal drawing process elongates the macroscale preform into a fiber having a pattern that maintains the original preform gradient arrangement in height and/or spacing. Given that the thermal drawing process elongates the preform to produce extensive lengths of fiber, it is preferred for most applications that the preform surface feature or layer feature extend the length of the preform so that the resulting fiber includes the feature or features along the fiber length. But an extensive feature, or a periodically-spaced array of features, is not required on a fiber preform; there can be provided on a fiber preform a single feature, as in FIGS. 5A-5B, such as a single trench 58, triangle 60, or other feature.

The preform body material can be configured in any suitable three-dimensional shape, such as rectangular, cylindrical, oval, polygonal, or other selected shape. The surfaces on which a feature or pattern is imposed need not be flat but a flat preform surface can be favorable to aid in the patterning process.

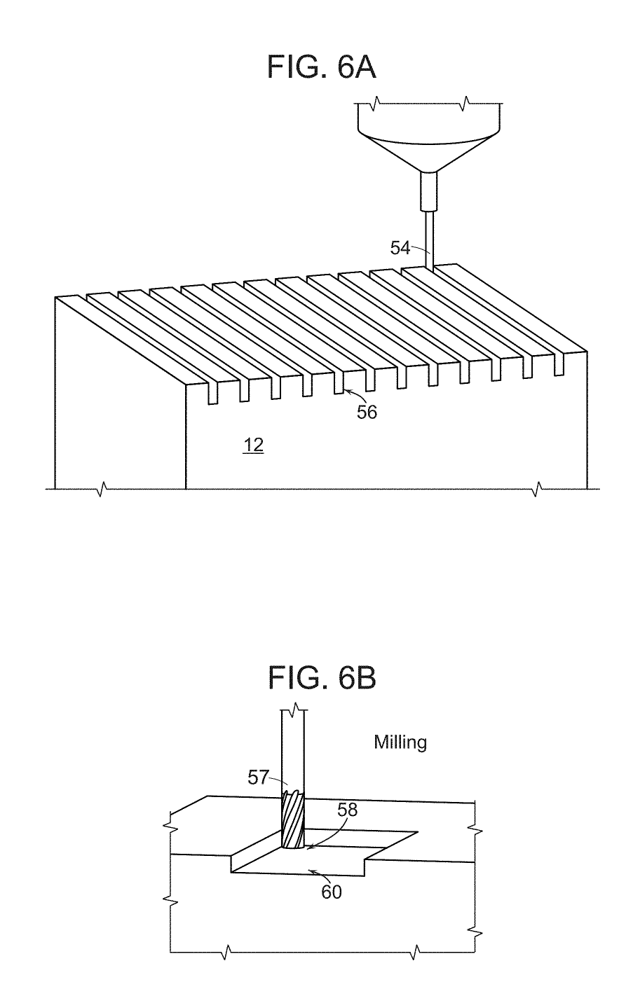

Any suitable preform feature formation and/or feature patterning technique can be employed and the physical processing of a preform surface or layer is not limited by the examples provided herein. In one embodiment, one or more conventional macro-scale tools are employed to physically process a preform layer or one or more of the preform surfaces. In one embodiment, the preform includes one or more planar surfaces to aid in and enable uniform patterning across the planar surface. Referring to FIG. 6A, in one embodiment, a laser light beam 54 is directed to the surface of the fiber preform 12 or a material layer to be included in the preform, and the laser light beam is rastered or otherwise directed to sites on the material to form features 56 in the material. The laser light beam wavelength, power, and raster speed are controlled to introduce to the material a dose of laser light energy that cuts the material; the depth of the cut is determined by the laser beam power.

Most nonmetallic materials are highly absorptive at the CO₂ laser wavelength of 10.6 μm, making a CO₂ laser a well-suited laser cutting device for a wide range of fiber materials, and making laser cutting a well-suited process in general for preform materials including, e.g., PMMA, rubber, polypropylene, polyoxy-methylene, polyester, polyethylene, fluoropolymers, and nylon-type polymers. The preform laser cutting process involves vaporization, melt shearing, or chemical degradation-based removal of the preform material. Preform feature sizes produced with laser cutting can be as small as, e.g., about 50 microns-100 microns. One particular advantage of the laser cutting method is the short processing time required to form a plurality of features across a surface. In only a few seconds to a few minutes there can be produced features over an entire preform surface or layer extent. The laser beam width can be selected to achieve pattern feature geometries and extents of interest. The laser light beam parameters are therefore preferably selected based on the material to be patterned and the dimensions of the pattern to be produced in the material. One example suitable laser system is a CO₂ laser system from Universal Laser Systems, Scottsdale, Ariz.

In a further embodiment, referring to FIG. 6B, a milling device, such as a mechanical milling tool 57, is directed to a region 58 or regions of the fiber preform surface or materials to be arranged in the fiber preform, to mill a feature 60 or features in the preform. Milling is particularly effective for patterning relatively stiff preform materials. Milling can be utilized to define sub-millimeter pattern feature extents with desired depth/width and can be applied to any suitable fiber preform materials, such as amorphous thermoplastics, and including, e.g., polycarbonate (PC), polytetrafluoroethylene (PTFE), poly(methyl methacrylate) (PMMA), and PI, and to metals. An example suitable milling system that can be employed is a TRAK PDM2 type CNC milling machine from Southwestern Industries, Inc., Rancho Dominguez, Calif.

In a further embodiment, there is provided a method for producing a patterned fiber having a pattern in a fiber material that may undergo a drop in viscosity during the thermal draw process. One class of materials that undergoes a rapid viscosity reduction during thermal draw conditions is semi-crystalline materials, such semi-crystalline polymers. Unlike amorphous polymers, which can be thermally drawn in a fiber preform arrangement at a high temperature that is even greater than the amorphous polymer glass transition temperature, semi-crystalline polymers undergo a rapid drop in viscosity at temperatures above the semi-crystalline polymer melting temperature. As a result, non-equilibrium pattern features imposed in a semi-crystalline polymer preform material may not be retained during thermal drawing of a patterned preform in the manner described above. Example materials that are characterized by viscosity reduction during thermal draw include, e.g., PVDF, polyethylene, and elastomeric COC.

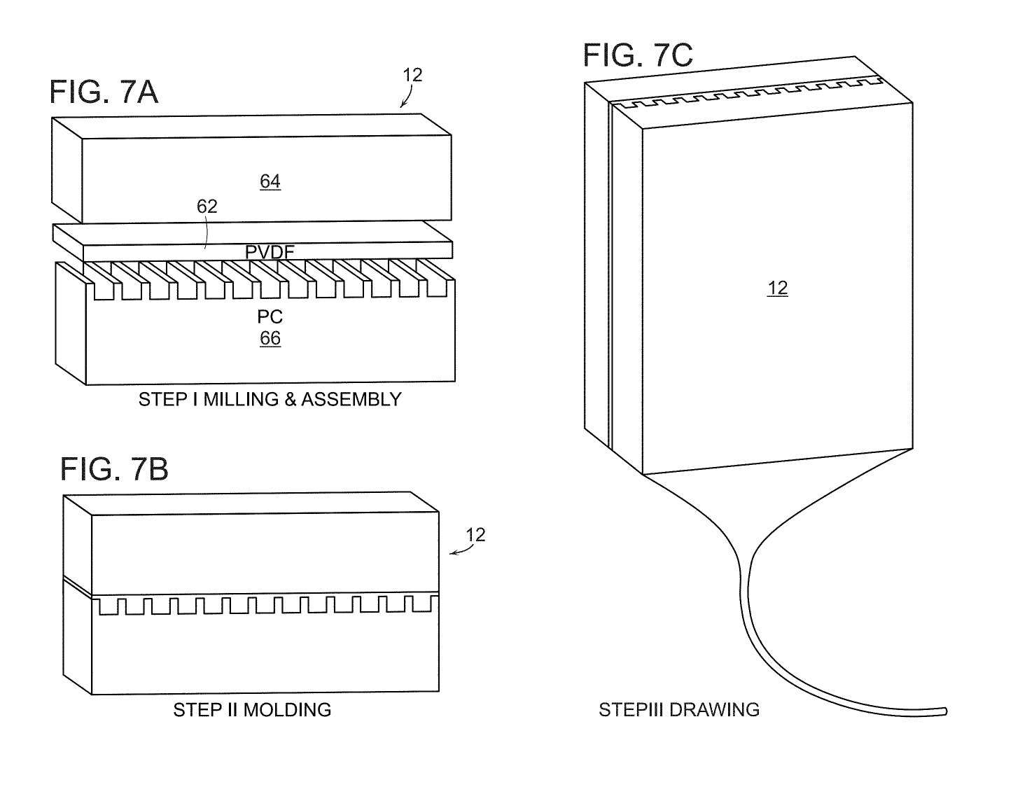

In one embodiment for patterning materials which are characterized by a drop in viscosity at thermal draw temperatures, a pattern is imposed on a fiber material in situ during the fiber draw. Referring to FIGS. 7A-7D, in this process, a preform 12 is configured with a layer of a preform material 62, such as polyvinyl difluoride (PVDF), or elastomeric COC, that is to be patterned, sandwiched between two rigid preform plates, 64, 66, formed of, e.g., PC or COC with one of the plates, 66, being patterned with a desired pattern, and/or with desired features, and the other plate 64 being un-patterned. The fiber preform 12 is otherwise assembled in a desired configuration. As shown in FIG. 7B, the preform 12 is then subjected to a thermal consolidation process, e.g., thermal heating at, e.g., between about 170° C. and about 190° C., for a duration of, e.g., between about one-half hour and one hour. During such a thermal consolidation, the temperature of the preform is held at or only slightly above the glass transition temperature of the mold layer but much higher than the melting temperature of the layer to be patterned, so that the mold layer maintains its shape but the patterning layer melts and fills the features of topology of the rigid mold layer. The consolidation temperature is therefore set to be greater than the melting temperature of the preform material to be patterned but only slightly above the glass transition temperature of the mold materials.

Referring to FIG. 7C, after the consolidation step, the preform 12 is thermally drawn. All of the mold layer material and the rigid mold layers are materials that can be co-drawn at a common draw temperature. For example, for the PVDF-PC material example here, a middle zone draw temperature of about 240° C., a feed speed of about 1 mm/min, a draw speed of about 1 m/min, and a stress of between about 400 g/mm² and about 1000 g/mm² enable co-drawing of the patterned mold and the moldable material. During the thermal draw, the pattern in the mold layer is reduced and the melted preform layer to be patterned, now in liquid form, follows this size reduction because the preform layer to be patterned is physically restricted from all sides, between the two plate layers. While the layer to be patterned is in a low-viscosity state during the draw, the pattern features are maintained due to the highly viscous boundaries between the layer to be patterned and the rigid adjacent layers. Referring to FIG. 7D, after thermal drawing of the preform into a fiber, the rigid mold layer 64 is peeled from the other layers of the fiber, producing a flexible, patterned fiber 14. This fiber peeling can be facilitated by employing materials having low adhesive strength at their interface, such PVDF/PC, which have a low adhesive strength at their interface.

For any preform patterning method, there can be imposed any selected geometrical arrangement of features. The patterned fiber fabrication method provided herein is particularly effective at producing hierarchical surface structures including patterns at different length scales. The production of such features is known to be very challenging using conventional patterning methods such as printing or lithography. Here, the macro-patterning of a fiber preform enables superior controllability at the macroscale, prior to thermal drawing at the microscale. For example, in one embodiment, there is milled on a preform surface a first grating pattern having a first periodicity, on top of which is imposed a second grating pattern with a smaller periodicity. This example demonstrates that a preform can be patterned at the macro-scale and then with the ease of the thermal draw process, all features of a pattern are miniaturized.

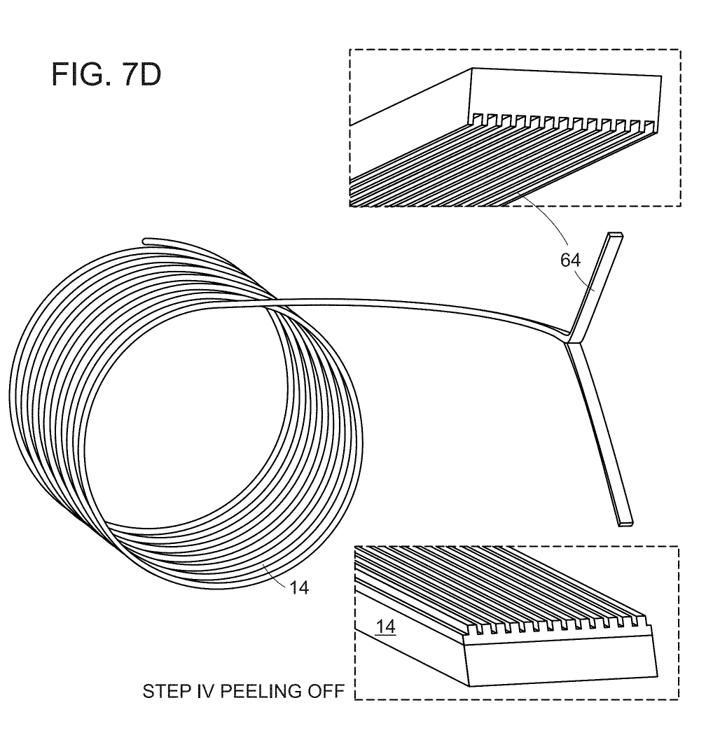

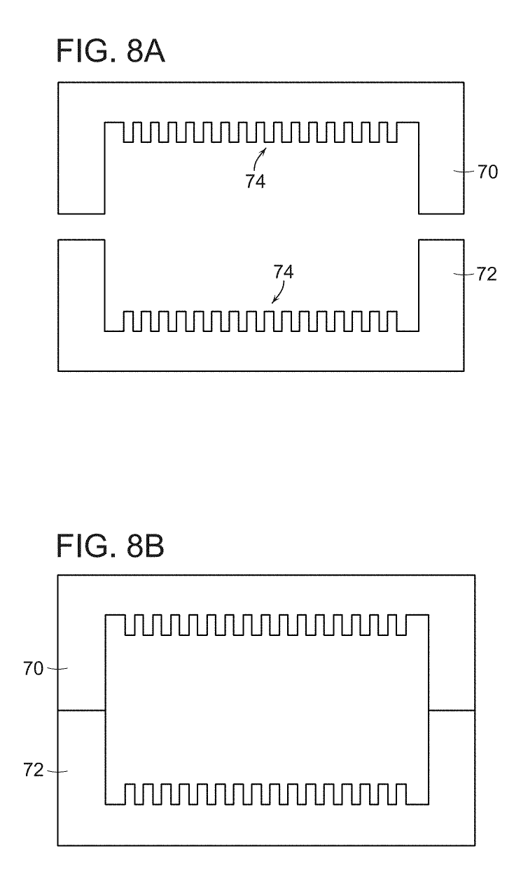

Referring to FIGS. 8A-8B, the methods described above can be employed to impose topology on inner surfaces of a preform. In a first step, preform sections 70, 72 can be separately processed in any desired manner to impose features 74 on an inner surface of a preform section. Additional preform layers, as well as preform domains, devices, and material geometries, are then added on the preform sections 70, 72. In a second step, the preform sections 70, 72 are mated and consolidated, forming a fully assembled preform having inner patterned layers. The preform is then thermally drawn in the manner described above to produce a patterned fiber including inner patterned surfaces.

Once a preform is assembled and, if desired, thermally consolidated, the preform can be further processed prior to the thermal drawing step. In one embodiment, filaments, wires, or other structures are fed into a hollow domain or domains of a preform as the preform is fed to the draw furnace, to include such structures in the drawn patterned fiber. In a further embodiment, the cross-sectional shape of the preform, e.g., the cross-sectional geometry, is changed along one or more portions of the heated preform as the thermal drawing process proceeds.

After thermal drawing of a patterned preform into a patterned fiber, further patterning of the fiber surface can be conducted. In one embodiment, a patterned fiber surface is stamped to impose additional surface topology along at least a portion of the fiber length, at any angle, or whether parallel with or perpendicular to the fiber length, or in a geometrical shape. A patterned mold, a patterned substrate, e.g., a silicon wafer, a surface-patterned fiber itself, or other structure can be employed as a stamp. In a post-thermal draw fiber stamping process, the fiber is heated to a temperature that is above the glass transition temp of the polymer fiber material to be stamped, for a duration of at least about a few mins. For example, for a PC fiber surface material to be stamped, stamping can be conducted at a stamping temperature of about 180° C. for a duration of between about 5 minutes and about 10 minutes.

In a further embodiment, the patterned fiber can be subjected to additional thermal processing to cause capillary break up of fiber materials in a manner that changes fiber patterns, e.g., periodic grating structures, into two-dimensional patterns. As taught in U.S. Pat. No. 9,512,036, issued Dec. 6, 2016; in U.S. patent application publication No. US2015/0044463, published Feb. 12, 2015; and in U.S. patent application publication No. US2016/0060166, published Mar. 3, 2016, the entirety of all of which are hereby incorporated by reference, Rayleigh-plateau instabilities of fiber materials can be controlled and exploited to cause break up of fiber materials along the longitudinal fiber axis to controllably adjust fiber material and patterns.

As a result, the patterned fiber can include, along the length of the fiber, first portions of the fiber length having a pattern different than that of second or other portions of the fiber length. The fiber pattern can be two-dimensional, one-dimensional, periodic, aperiodic, or in another arrangement, and can exist on one or more outer fiber surfaces or around the entire outer fiber surface circumference, whether the fiber is cylindrical, rectangular, or in another cross-sectional geometry.

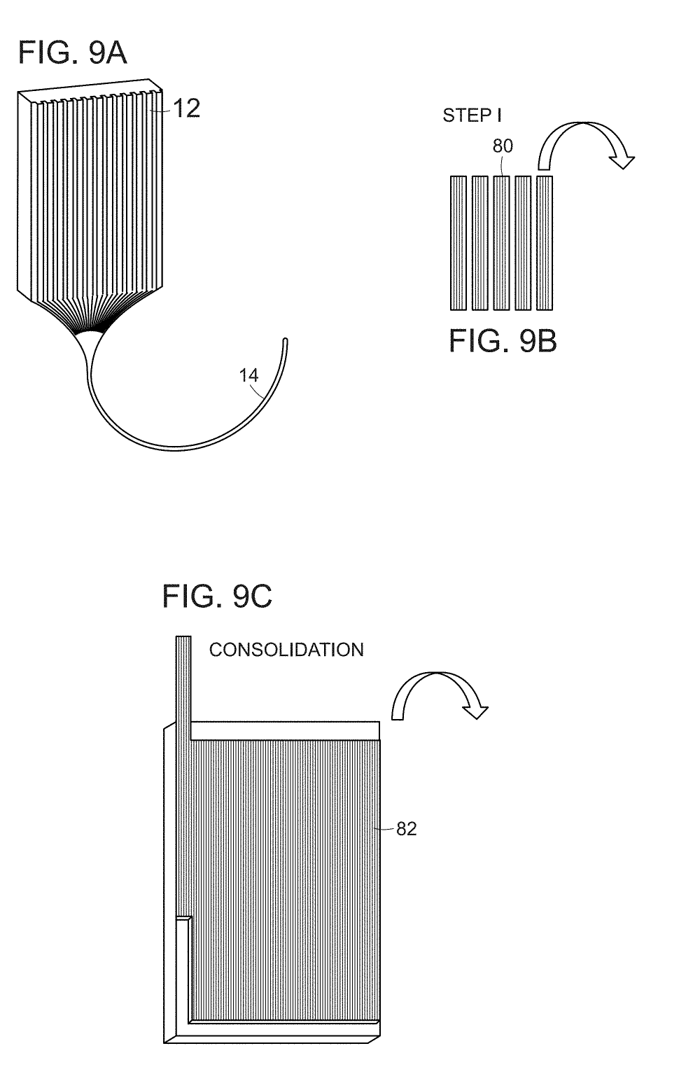

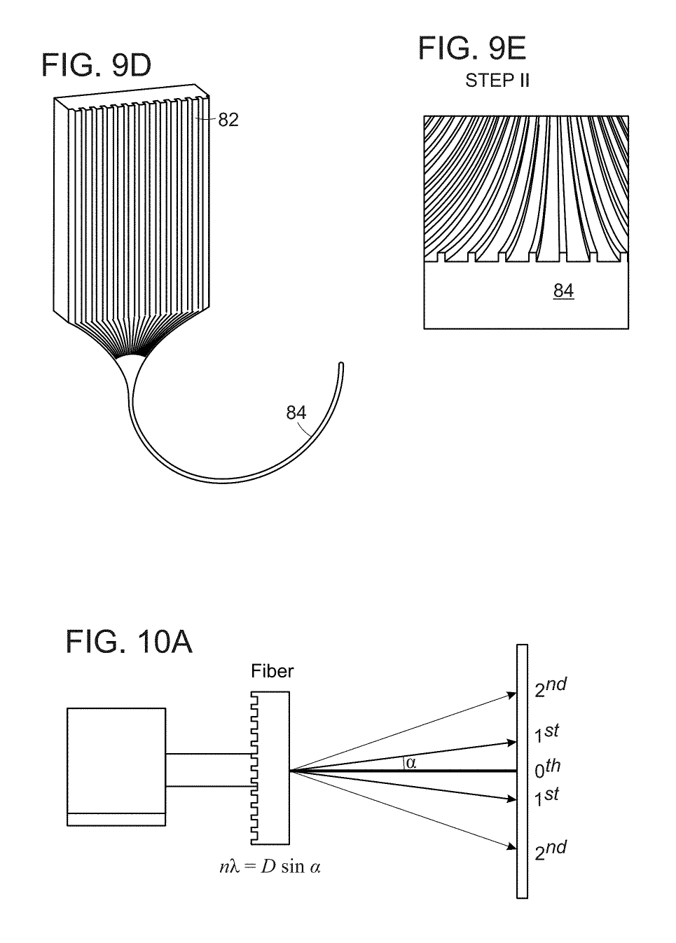

Referring to FIGS. 9A-9E, in a further embodiment, a patterned preform 12 is thermally drawn into a patterned fiber 14 and the fiber length is cut into fiber portions 80 that are together assembled as a cut-patterned fiber preform 82 shown in FIG. 9B-9C. The cut-patterned fiber preform 82 is consolidated, and then as shown in FIG. 9D is subjected to a second thermal drawing process to form a compound patterned fiber 84. Any number of thermal drawing steps can be iterated. After a second thermal drawing step, the resulting compound patterned fiber 84 can include, e.g., more than 1000 nanogratings. This embodiment therefore provides a patterned fiber having a periodic grating structure of at least 1000 nanogratings.

In the Examples below, polymer materials are employed for thermally drawing a multi-material, patterned fiber preform. Example polymers and their properties are given below in Table I.

| | | | Thermal |
|---|---|---|---|
| Polymer | Tensile strength, psi | Density, lbs/in³ | expansion, in./in./° F. |
| PMMA | 8,100-11,030 | 0.043 | 3.0 to 4.0 × 10⁻⁵ |
| PC | 8,000-16,000 | 0.043-0.048 | 1.5 to 3.8 × 10⁻⁵ |
| PVDF | 7,550-7,800 | 0.064 | 7.1 × 10⁻⁵ |

### EXAMPLE I

### Preform Milling and Thermal Draw into Patterned Fiber

A slab of PC having dimensions of 1.5 inches-wide and 0.5 inches-thick was prepared with PC from McMaster-Carr, Elmhurst, IL. A TRAK DPM2 type CNC end mill milling machine, by Southwestern Industries, Inc., was employed to cut periodically-spaced trenches across the surface of the 1.5 inch-wide slab surface. The end mill was a 0.5 mm-diameter square-shape end mill. Trenches were cut into the PC with a 1 millimeter period, producing a feature pattern with 0.5 mm-wide pillars and 0.5 mm-wide trenches. The patterned preform was thermally drawn at a draw temperature of 260° C. with a preform feeding speed of 1 mm/min and a drawing speed of 2.5 m/min. The ratio of these speeds set the draw down ratio to be 50. The resulting drawn fiber had 10 micron-wide pillars spaced apart from each other by 10 microns.

### EXAMPLE II

### Preform Laser Cutting and Thermal Draw into Patterned Fiber

A 1.5 inch-wide and 0.25 inch-thick PMMA slab was arranged as a fiber preform. Periodically-spaced trenches were cut into the 1.5 inch-wide PMMA preform surface with a 1 millimeter period, producing a structure with 0.5 mm-wide pillars and 0.5 mm-wide trenches. The PMMA surface was ablated to a greater extent than at depths within the PMMA thickness, so that the ablation was reduced at deeper penetration depths below the surface. This resulted in a trapezoidal pattern in cross section. The patterned PMMA preform was thermally drawn at a draw temperature of 240° C. with a preform feeding speed of 1 mm/min and a drawing speed of 2.5 m/min. The resulting drawn fiber had a periodically-spaced trapezoidal trench pattern, based on the draw down ratio of 50, of 10 micron-wide trapazoidal pillars spaced apart from each other by 10 microns.

### EXAMPLE III

### Patterned Fiber Diffraction Grating and Textile

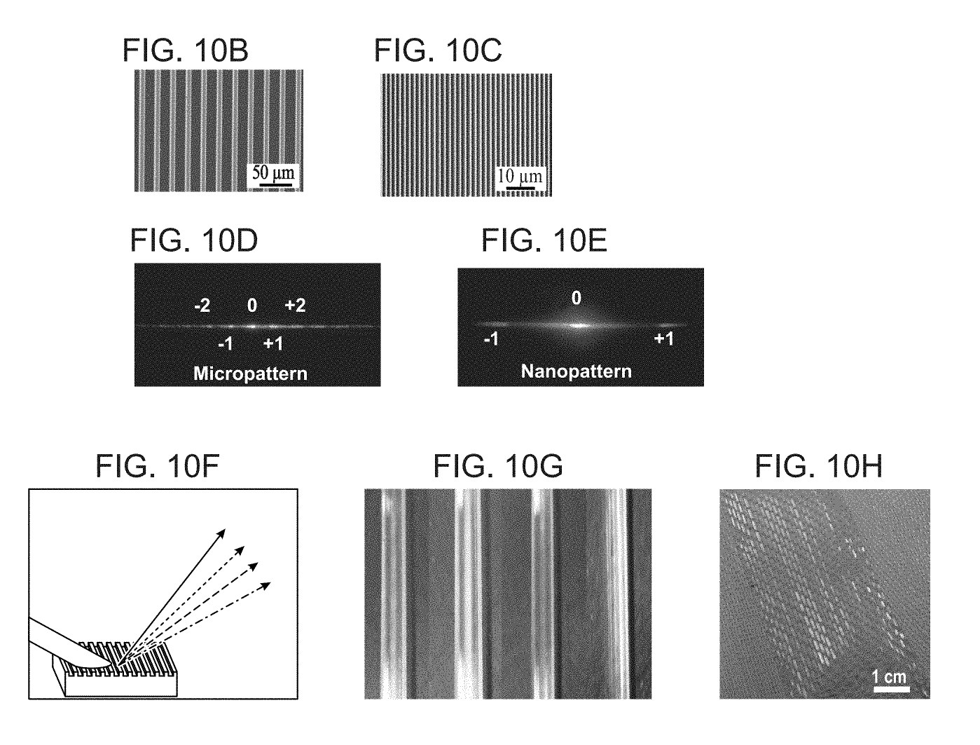

It is known that light diffracts as light passes through a slit having a size comparable to the wavelength of the light. Herein is provided a patterned fiber having diffraction gratings on the outer fiber surface that provide fiber-based optical gratings for diffraction applications. An experimental setup for measuring the diffraction patterns produced with the patterned fiber gratings is shown in FIGS. 10A-E. Two patterned fibers were thermally drawn from PC fiber preforms having gratings patterned thereon. The PC preform was thermally drawn at a middle draw zone temperature of about 240° C. with a preform feed speed of about 1 mm/min, a draw speed of about 1 m/min, and a stress of between about 400 g/mm² and 1000 g/mm². The first fiber had a surface grating pattern with a grating period of 23.67 microns and the second fiber had a surface grating pattern with a grating period of 1.73 microns.

A red laser was transmitted through the patterned fibers. The corresponding diffraction order for the patterned fiber of FIG. 10B is shown in FIG. 10D. The diffraction order for the patterned fiber of FIG. 10C is shown in FIG. 10E. The diffraction angle was calculated by measuring the distance between the measured orders.

A basic calculation using the diffraction formula nλ=D sin α (where n represents diffraction order, λ is the wavelength of light, α is the diffraction angle for different orders, and D is the period width) confirms that the D values (D₁=23.57 μm and D₂=1.748 μm) match the measurements from SEM images of the patterned fibers (D₁=23.67 μm and D₂=1.73 μm) to within 1%. It is apparent from both the measurement and the calculation that when the width of the fiber grating period decreases the number of supported orders also decreases and each supported order covers a larger space in the polar domain. This fact, combined with the axial and transverse fiber uniformity, gives rise to the observed vivid coloration when the period becomes comparable to the visible light wavelengths (i.e. 400-750 nm). FIGS. 10F-G show how a patterned fiber surface can fiber exhibit different colors when viewed from different angles.

In one embodiment, there is provided a textile in whcih a patterned fiber is woven. An example of such is shown in FIG. 10H. By weaving one ore more surface-patterned fibers into a textile material, e.g., with natural or synthetic threads, fibers, or filaments, angle-dependent chemical-free structural coloration effects are provided over a large-area textiles. FIG. 10H is a photographe of an 8-harness satin weave fabric construction including patterned polymer fibers woven into the textile. This fabric construction facilitates maximum patterned fiber surface exposure for enabling structural coloration effects of the textile as a result of perioid grating pattern on the polymer fiber woven into the textile fabric.

### EXAMPLE IV

### Patterned Fiber Control of Surface Wetting Properties

It is known that surface wetting behavior on a patterned grating surface is drastically different transverse to the grating pattern compared to parallel with the grating pattern. A patterned PC fiber was fabricated by assembling a PC preform that was thermally drawn at a middle draw zone temperature of about 240° C. with a preform feed speed of about 1 mm/min, a draw speed of about 1 m/min, and a stress of between about 400 g/mm² and 1000 g/mm². The preform was provided with a grating on one surface for producing a thermally drawn fiber having a grating pattern on one surface thereof. The wetting properties of a non-patterned surface of the fiber were then compared with those of a patterned surface of the fiber.

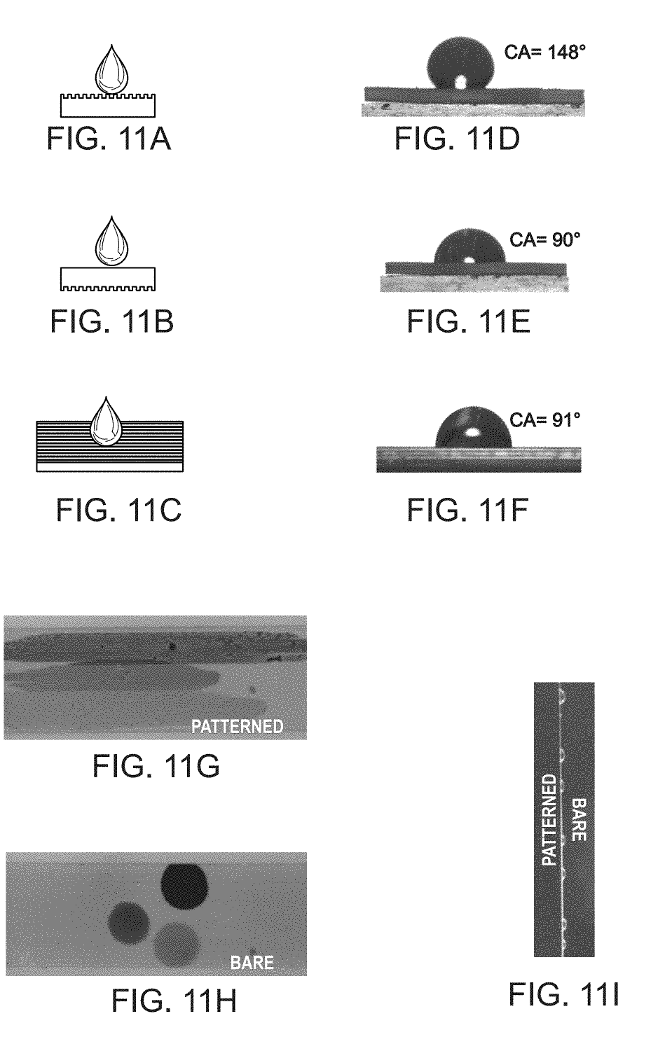

Referring to FIGS. 11A-C, for the non-patterned fiber surface (FIG. 11B), an isotropic contact angle (CA) value of 90° was measured, as shown in FIG. 11E, which is in accordance with the CA value measured on PC slabs prior to drawing, confirming that the drawing process itself does not induce anisotropic wetting. However, when a water drop was placed on the patterned fiber surface side (FIG. 11A), the CA in the transverse direction significantly increased (CA=148°) as shown in FIG. 11D, while in the longitudinal direction the CA was around 91°, a shown in FIG. 11F, leading to a wetting anisotropy of Δθ=57°. The enhanced hydrophobicity in the transverse direction can be explained by considering the structured surface profile and employing the Cassie-Baxter wetting model. We hypothesize that this model is applicable to our scenario due to the micron-sized features of the surface structure, the small ratio between grating width to the period, and the fact that the CA increases beyond 90° for the modified surface. For this type of surface, hydrophobicity is increased due to the trapping of air in the grooves of the grating, thereby increasing the effective interfacial surface energy. It should also be noted that the gratings utilized in this experiment have hemispherical-like edges (which gives even better hydrophobic properties), therefore a modified Cassie-Bexter model should be used for a more accurate estimation of the CA. The contact angle from this model can be estimated by the following formula:

(cos θ*=−1+θ_{B} (cos θ+1)²), (1)

where θ is the CA of the bare surface and On is the ratio of the grating surface area to the surface area of a period. From the cross-sectional SEM image of the fiber used in the measurement, it was estimated that O_{B}≈1/7 (cos θ=0, θ=90°) resulting in the calculation of θ*≈149°, which matches the experimental result to within 1°. The Contact Angle measurement was taken on a rame-hart model 500 from rame-hart Instrument co.

The anisotropy in the contact angle that is achieved for the patterned fibers provided herein are exploited in one embodiment for controlling fluid transport. The potential of anisotropic wetting for facilitating surface-energy-driven fluid flow on a patterned fiber was demonstrated by introducing a flow of fluid onto the surface with the tip of a liquid marker pen. The main carrier solvent used in the ink was isopropanol. Upon touching the patterned surface, the ink from the marker pen preferably flowed along the grating axis while it was restricted along the transverse axis. This enabled the simultaneous transport of different fluids on the same fiber surface, as illustrated by flowing different color inks along the fiber without mixing, shown in FIG. 11G. As a comparison, the axial flow of the ink was not observed when introducing it to a non-patterned bare fiber surface, shown in FIG. 11H.

This demonstrates the ability to achieve directional and confined flow on the patterned surface of one single, individual fiber without employing any chemical treatments. Moreover, the surface patterned fiber displays water repellency. When the fiber is placed vertically, the anisotropic hydrophobicity and gravity facilitates the flow of water along the grating, thus preventing water droplets from staying on the surface. As a comparison, on the non-patterned side of the fiber, water droplets remain on the surface, as shown in FIG. 11I. Textiles including woven grating-patterned fibers can be employed for directional liquid flow on the textile, and for producing hydrophobic textiles and fabrics.

The fiber preform can be assembled with any convenient cross-sectional geometry that produces a thermally-drawn patterned fiber for a selected application such as the textile fabric applciations described above. Micro-structured ribbon fibers, having a relatively planar cross-section, such as a thin rectangle, along the fiber length, can be employed. Cylinderical, square, oval, and other cross-sectional fiber geometries can be employed for a given textile, fabric, or other application. The thickness of a thermally drawn patterned fiber can be less than 100 μm, which is comparable to a conventional textile fiber size. The cross-sectional extent of a thermally drawn patterned fiber can also be less than 100 μm for use in many applications.

With the description and examples above, there is provided a mechanically flexible, thermally-drawn patterned fiber of extended length, e.g., km-long, having one or more patterned surfaces. The fiber can be woven, stitched, or otherwise incorporated into a textile, fabric, or other structure, and in that structure, can provide a range of properties, including, e.g., directional wetting and structural coloration, as described above.

The process provided herein for thermal drawing of a patterned fiber preform enables the scaling down of pattern features from millimeter scale at the preform to submicron scale at the fiber. This method enables the patterning of amorphous and semi-crystalline polymers with widely disparate chemical properties, including fluoropolymers, acrylates, carbonates, and olefins. With the ability to produce kilometers of microscale topological fiber features, the process provided herein enables a wide range of applications, including micro-fluidics and nano-fluidics, plasmonic metasurfaces, smart surfaces, organic photonic, biosensors, smart textiles, and other applications.

It is to be recognized that modifications to the disclosed embodiments of fibers, preforms, and thermal drawing processes as-claimed are possible and are within the scope of the inventions as-disclosed.

What is claimed is:

1. A method for forming a patterned fiber comprising:
assembling a fiber preform including at least one preform material, the at least one preform material having a viscosity lower than about 10⁸ Poise at a common thermal fiber draw temperature;
physically patterning a surface of at least one preform material and arranging a resulting patterned preform material surface as a fiber preform surface to provide a topological pattern on said fiber preform surface; and
thermally drawing the fiber preform into an elongated thermally drawn fiber at a fiber draw temperature at which all preform materials have a viscosity lower than about 10^{8 Poise.}

2. The method of claim 1 wherein physically patterning a surface of at least one preform material comprises at least one process selected from the group consisting of laser beam cutting, mechanical milling, and molding.

3. The method of claim 1 wherein physically patterning a surface of at least one preform material comprises forming a grating pattern on a surface of at least one preform material.

4. The method of claim 1 wherein physically patterning a surface of at least one preform material comprises forming a periodic pattern on a surface of at least one preform material.

5. The method of claim 1 wherein physically patterning a surface of at least one preform material comprises physically patterning a surface of a plurality of preform materials and arranging resulting patterned preform materials as a plurality of fiber preform surfaces to provide a topological pattern on a plurality of fiber preform surfaces.

6. The method of claim 1 wherein physically patterning a surface of at least one preform material comprises physically patterning a surface of a plurality of preform materials and arranging resulting patterned preform materials as a plurality of fiber preform surfaces to provide a topological pattern on a plurality of fiber preform surfaces.

7. The method of claim 1 further comprising:
producing a plurality of fiber sections from said elongated thermally drawn fiber;
assembling a preform including the plurality of fiber sections; and
thermally drawing the preform including the plurality of fiber sections.

8. The method of claim 1 wherein arranging a patterned preform material surface as a fiber preform surface comprises arranging a patterned preform material surface as an internal fiber preform surface.

9. The method of claim 1 wherein:
assembling a fiber preform including at least one preform material comprises assembling a fiber preform including a moldable material and a patterned mold material, the moldable material having a moldable material viscosity that is lower than a patterned mold material viscosity of the patterned mold material at a common thermal fiber draw temperature; and
wherein physically patterning a surface of at least one preform material and arranging a resulting patterned preform material surface as a fiber preform surface to provide a topological pattern on said fiber preform surface comprises physically patterning said mold material and arranging said mold material adjacent to said moldable material to provide a topological pattern on an internal fiber preform surface;
and further comprising, after thermally drawing the fiber preform into an elongated thermally drawn fiber, peeling said mold material from said moldable material along a length of the elongated thermally drawn fiber.

10. The method of claim 1 wherein assembling a fiber preform including at least one preform material comprises assembling a fiber preform including at least one preform material selected from the group consisting of thermoplastics, PMMA, semicrystalline polymers, polyethylene, PVDF, fluoropolymers, PVDF, acrylates, PMMA, carbonates, PC, olefins, COC, PC, PET, PT, PSU, elastomers, polyetherimide, PTFE, and metals.

11. A fiber comprising:
an elongated, unsupported, three-dimensional fiber body having a fiber body length and including at least one fiber material disposed along the fiber body length, the at least one fiber material having a viscosity lower than about 10⁸ Poise at a common thermal fiber draw temperature; and
at least one topological pattern disposed on at least one surface of the fiber body and extending longitudinally along at least a portion of the fiber body length.

12. The fiber of claim 11 wherein the at least one fiber material is selected from the group consisting of thermoplastics, PMMA, semicrystalline polymers, polyethylene, PVDF, fluoropolymers, PVDF, acrylates, PMMA, carbonates, PC, olefins, COC, PC, PEI, PI, PSU, elastomers, polyetherimide, PTFE, and metals.

13. The fiber of claim 11 wherein the at least one topological pattern extends longitudinally along substantially all of the fiber body length.

14. The fiber of claim 11 wherein the at least one topological pattern comprises a grating.

15. The fiber of claim 11 wherein the at least one topological pattern comprises a periodic pattern.

16. The fiber of claim 11 wherein the at least one topological pattern comprises a plurality of patterns.

17. The fiber of claim 11 wherein the at least one topological pattern comprises at least one topological pattern disposed on a plurality of surfaces of the fiber body.

18. The fiber of claim 11 wherein the at least one topological pattern disposed on at least one surface of the fiber body comprises a topological pattern disposed on an internal surface of the fiber body.

19. The fiber of claim 11 further comprising a plurality of textile threads arranged in a weave pattern around the fiber body and along the fiber body length.

20. The fiber of claim 11 wherein the at least one fiber material disposed along the fiber body length comprises a plurality of materials disposed along the fiber body length.
